(19) United States
(12) Patent Application Publication
(10) Pub. No.: US 2006/0268035 A1
(43) Pub. Date: Nov. 30, 2006

(54) Ink-jet image forming apparatus and method for compensating for defective nozzle

(75) Inventors: Jung-hwa Lee, Suwon-si (KR); Masahiko Habuka, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/362,715

(22) Filed: Feb. 28, 2006

(30) Foreign Application Priority Data
May 25, 2005 (KR) 2005-44228

(51) Int. Cl. B41J 29/38

(52) U.S. Cl. 347/12

(57) ABSTRACT

An ink-jet image forming apparatus and method for compensating for a defective nozzle are provided. The ink-jet image forming apparatus includes a recording medium transferring unit to transfer a recording medium in a first direction, a printhead to extend substantially parallel with a second direction, the second direction transversing the first direction, on which a nozzle unit is defined, the nozzle unit having nozzles through which ink droplets are ejected onto the recording medium, a carriage with the printhead mounted thereon, a carriage transferring unit to reciprocate the carriage in the second direction, and a controller to synchronize operations of the recording medium transferring unit, the printhead, and the carriage transferring unit, and to print the ink droplets ejected by the nozzles in a desired position of the recording medium so as to disperse an effect of a defective nozzle. The method includes: receiving a printing environment, detecting the defective nozzle in the nozzle unit by a detecting unit, and reciprocating the printhead in a longitudinal direction to disperse an effect of the defective nozzle.

### CROSS-REFERENCE TO RELATED APPLICATIONS

This application claims the benefit of Korean Application No. 2005-0044228, filed May 25, 2005, in the Korean Intellectual Property Office, the disclosure of which is incorporated herein by reference.

### BACKGROUND OF THE INVENTION

1. Field of the Invention

An aspect of the present invention relates to an ink-jet image forming apparatus, and, more particularly, to a page-width ink-jet image forming apparatus capable of compensating for deterioration of printing quality due to a defective nozzle that poorly ejects ink droplets, and a method of compensating for the defective nozzle.

2. Description of the Related Art

Generally, an ink-jet image forming apparatus forms an image by ejecting ink droplets via a printhead reciprocating in a direction perpendicular to a traveling direction of a recording medium. This type of apparatus is referred to as a shuttle-type ink-jet image forming apparatus. The shuttle-type ink-jet image forming apparatus includes a printhead having a nozzle unit provided with a plurality of nozzles through which ink droplets are ejected.

Recently, to satisfy commercial requirements for high printing speed, there have been attempts to perform high-speed printing using a printhead having a length corresponding to a width of the recording medium. An apparatus operating in this manner is referred to as a page-width ink-jet image forming apparatus. In a conventional page-width ink-jet image forming apparatus, a printhead is stationary. In other words, in these devices, only the recording medium moves. Thus, nozzles provided in the printhead are in a one-to-one relationship with each other along the conveying direction of the recording medium. Hence, if any one of the nozzles arranged as described above does not operate properly, a white or missing line appears in a printed image on the recording medium.

FIG. 1 illustrates a printing pattern due to a defective nozzle in a conventional page-width ink-jet image forming apparatus. FIGS. 2A through 2D illustrate a method of compensating for the defective nozzle in a conventional inkjet image forming apparatus.

Referring to FIG. 1, the ink-jet image forming apparatus forms an image on a recording medium by ejecting ink droplets on the recording medium through a plurality of nozzles 82 provided in a nozzle unit 80. The nozzle unit 80 is installed in a printhead in a direction so as to be perpendicular to a conveying direction of the recording medium and ejects ink droplets onto the recording medium to form images thereon. If a nozzle 84 among the nozzles 82 fails to operate properly, the defective nozzle 84 does not eject ink droplets onto the recording medium. Hence, a missing line, i.e., a white line, appears in the printed image on the recording medium, as shown in FIG. 1. Although such a printing defect may not matter or be noticed when an image with a low printing density is formed, when printing a solid pattern or an image with a high printing density, a white line appears in a printed image in the conveying direction of the recording medium and remarkably affecting the printing quality.

In the case of the shuttle type apparatus, a method of overprinting an image by reciprocating a carriage several times has been used to compensate for deterioration of printing quality due to a defective nozzle. This method is referred to as a shingling method. In the case of a page width type apparatus, the printhead is disposed in a direction perpendicular to the conveying direction of the recording medium, and does not reciprocate along a width direction of the recording medium. Thus, an area on the recording medium is printed by one nozzle at a specific time during printing. If the nozzle fails to operate, a white line as shown in FIG. 1 appears in the printed image, which deteriorates the printing quality. A method of compensating for deterioration of printing quality, a defective nozzle is disclosed in U.S. Pat. No. 5,581,284.

The above patent discloses a method of compensating for a defective nozzle in a page-width ink-jet image forming apparatus. Herein, the defective nozzle is a nozzle that does not normally eject ink droplets. The method comprises monitoring a defective nozzle 63 that ejects monochromatic ink, i.e., black ink, droplets, as shown in FIG. 2A. Where the defective nozzle is to be used, other colors, i.e., cyan, magenta, and yellow ink droplets, are sequentially ejected on the area to be printed by the defective nozzle. This process is shown in FIGS. 2B, 2C, and 2D. As described above, if the cyan, magenta, and yellow ink droplets are ejected on the same position in a droplet-on-droplet manner, a black pixel may be represented in the printed image.

Black colored ink, formed in this manner, are referred to as process blacks or composite blacks. Although the above described method is useful to compensate for the black pixels, the method is useful in compensating for other colored pixels. In other words, when only black ink droplets are required for a printing operation, since the cyan, magenta, and yellow ink nozzles may not operate properly, the process black may be produced using operating black ink nozzles. However, when a color image is to be printed on a recording medium, i.e., when the cyan, magenta, and yellow ink nozzles are required to be operating, compensating for the missing line present when these nozzles are not working properly is impossible using conventional methods. Also, where one of nozzles compensating for a missing nozzle is itself defective, the missing line may be replaced with a color line instead of a process black, i.e., red (yellow+magenta), green (cyan+yellow), blue (cyan+magenta), or the like, thereby significantly affecting the printing quality.

According to the above described related art, a defective nozzle causes printing failure, such as a white line, which is easily noticed by a user. Such a printing failure causes problems in an image forming apparatus pursuing high-quality, high-speed printing. Therefore, compensating for such failures is required improve the printing quality.

### SUMMARY OF THE INVENTION

An aspect of the present invention provides an ink-jet image forming apparatus and method of compensating for a failed or defective nozzle or a nozzle which does not normally eject ink droplets in order to prevent printing quality deterioration.

An aspect of the present invention provides an ink-jet image forming apparatus and method for compensating for a failed or missing nozzle, which minimizes the effect of the defective nozzle by solving a limitation of U.S. Pat. No. 5,581,284.

According to an aspect of the present invention, there is provided an ink-jet image forming apparatus including: a recording medium transferring unit to transfer a recording medium in a first direction; a printhead to extend substantially parallel with a second direction, the second direction transversing the first direction, on which a nozzle unit is defined, the nozzle unit having nozzles through which ink droplets are ejected onto the recording medium; a carriage with the printhead mounted thereon; a carriage transferring unit to reciprocate the carriage in the second direction; and a controller to synchronize operations of the recording medium transferring unit, the printhead, and the carriage transferring unit, and to print the ink droplets ejected by the nozzles in a desired position of the recording medium so as to disperse an effect of a defective nozzle.

The ink-jet image forming apparatus may further include a detecting unit to detect a defective nozzle in the nozzle unit.

The ink-jet image forming apparatus may further include: a data input unit to receive image data to be printed; and a printing environmental information unit to store a plurality of pieces of printing environmental information corresponding to a printing environmental when the image data inputted to the data input unit is printed under a desired printing environment, wherein the controller regulates a reciprocating range of the carriage according to the printing environmental information stored in the printing environmental information unit and information on the defective nozzle detected by the detecting unit.

The printing environment may include a printing density, a resolution, a size of the recording medium, a kind of the recording medium, a temperature, humidity, and consecutive printing information.

The carriage transferring unit may include: a driving unit to reciprocate the carriage; and a guide unit to guide the carriage.

The driving unit may include a piezoelectric actuator coupled to the carriage to reciprocate the carriage.

A connection may penetrate the carriage, and the guide unit may include a guide shaft inserted into the connection for guiding the carriage.

The guide unit may include a guide rail to guide the carriage.

A large nozzle and a small nozzle may be alternatively arranged in the nozzle unit.

According to another aspect of the present invention, there is provided a method of compensating for a defective nozzle in an ink-jet image forming apparatus including a printhead having a nozzle unit of a length at least corresponding to a width of the recording medium, the method including receiving a printing environment; detecting the defective nozzle in the nozzle unit by a detecting unit; and reciprocating the printhead in a longitudinal direction to disperse an effect of the defective nozzle.

The printing environment may include a printing density, a resolution, a size of the recording medium, a kind of the recording medium, a temperature, humidity, and consecutive printing information.

The reciprocating may comprise determining whether the defective nozzle corresponds to an area to be printed. If the defective nozzle does not correspond to the area to be printed, the method may further comprise performing printing normally.

The method may include synchronizing an operation of transferring the recording medium by a recording medium transferring unit, an operation of ejecting an ink droplet by the printhead, and an operation of reciprocating the printhead, thereby printing the ink droplets in a desired position on the recording medium.

A large nozzle and a small nozzle may be alternatively arranged in the nozzle unit.

Additional and/or other aspects and advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a view illustrating a printing pattern resulted from a defective nozzle in a conventional ink-jet image forming apparatus;

FIGS. 2A through 2D are views illustrating a method of compensating for a defective nozzle in a conventional ink-jet image forming apparatus;

FIG. 3 is a schematic sectional view of an ink-jet image forming apparatus according to an embodiment of the present invention;

FIG. 4A is a view illustrating a nozzle unit according to an embodiment of the present invention;

FIG. 4B is a view illustrating a nozzle unit according to another embodiment of the present invention;

FIG. 5 is a perspective view of a printhead unit and a carriage transferring unit according to an embodiment of the present invention;

FIG. 6 is a perspective view of a printhead unit and a carriage transferring unit according to another embodiment of the present invention;

FIG. 7 is a block diagram illustrating a construction of an image forming system according to an embodiment of the present invention;

FIG. 8 is a block diagram for explaining a method of compensating for a defective nozzle according to an embodiment of the present invention;

FIG. 9 is a flowchart of a method of compensating for a defective nozzle according to an embodiment of the present invention; and

FIG. 10 is a view illustrating an operation of compensating for a defective nozzle of an ink-jet image forming apparatus according to an embodiment of the present invention when printing an image in a solid pattern.

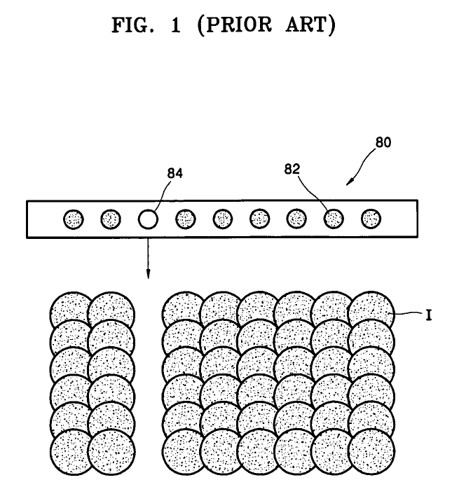

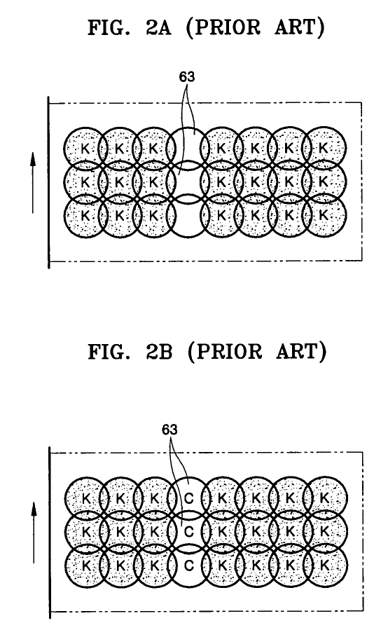

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

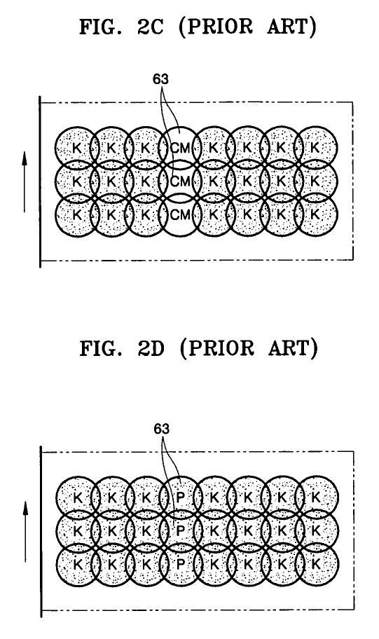

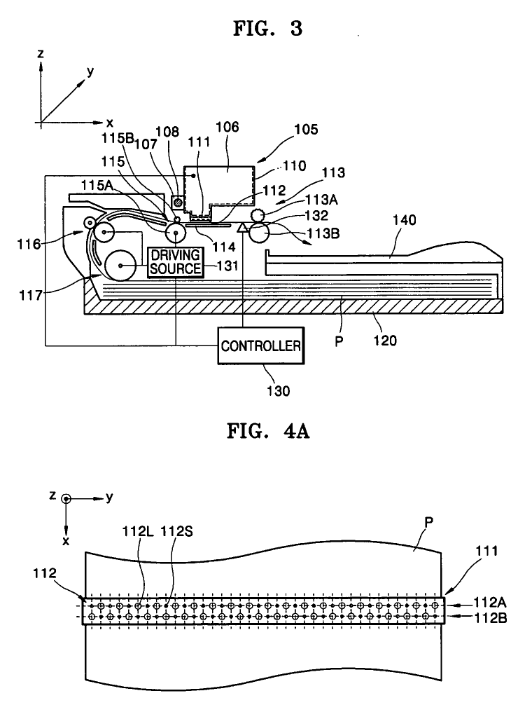

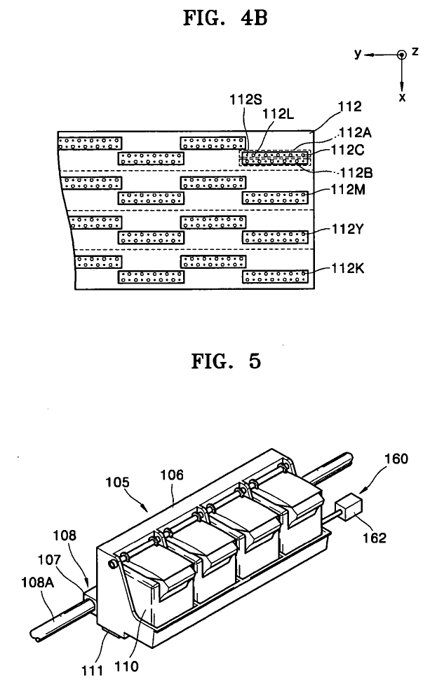

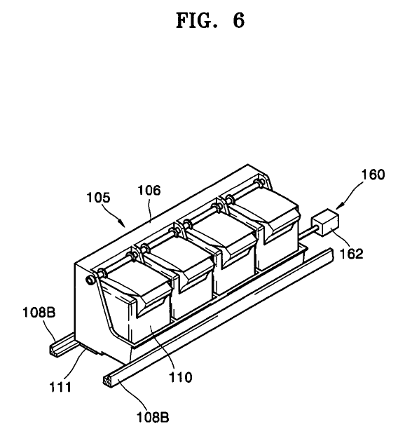

FIG. 3 is a schematic view illustrating an ink-jet image forming apparatus according to an embodiment of the present invention. FIG. 4A is a view illustrating a nozzle unit of the apparatus of FIG. 3, according to an embodiment of the present invention, and FIG. 4B is a view illustrating a nozzle unit according to another embodiment of the present invention. FIG. 5 is a perspective view illustrating a printhead unit and a carriage transferring unit of the apparatus of FIG. 3, according to an embodiment of the present invention. FIG. 6 is a perspective view illustrating a printhead unit and a carriage transferring unit according to another embodiment of the present invention.

Referring to FIG. 3, the ink-jet image forming apparatus includes a paper feeding cassette 120, a pickup roller 117, a printhead unit 105, a support member 114 disposed opposite to the printhead unit 105, recording medium transferring unit including a pickup roller 117, a feeding roller 115, and a delivering roller 113 to convey a recording medium P in a first direction, and a stacking unit 140 for delivering and stacking the recording medium P.

The recording medium P is loaded in the paper feeding cassette 120. Then, the recording medium P is conveyed to the printhead 111 by the recording medium transferring units 117, 115, and 113. The recording medium P is conveyed in the first direction, i.e., the x-coordinate direction of FIG. 3, whereas a second direction, i.e., the y-coordinate direction of FIG. 3, indicates a width direction of the recording medium P. The first direction and the second direction are set to be perpendicular to each other, however, in some embodiments, the first direction and second direction may be inclined with respect to each other at a desired angle.

The recording medium transferring units 117, 115, and 113 convey the recording medium P along a given path, and include the pickup roller 117, the feeding roller 115, and the delivering roller 113 in this embodiment. The recording medium transferring units 117, 115 and 113 are driven by a driving source 131, such as a motor, to provide a conveying force to convey the recording medium P. The operation of the driving source 131 is controlled by a controller 130.

The pickup roller 117 is installed to one side of the paper feeding cassette 120, and picks up and feeds the recording medium P loaded in the paper feeding cassette 120 one by one. When the pickup roller 117 rotates, the pickup roller 117 presses against an upper surface of the recording medium P, such that the recording medium P is conveyed outwardly from the paper feeding cassette 120.

The feeding roller 115 is installed to an inlet side of the printhead 111, and conveys the recording medium P, which is fed by the pickup roller 117, to the printhead 111. The feeding roller 115 may align the recording medium P to eject ink droplets on a desired portion of the recording medium P, before the recording medium P passes through the printhead 111. The feeding roller 115 includes a drive roller 115A to provide the conveying force to convey the recording medium P, and an idle roller 115B to resiliently mesh with the drive roller 115A. The feeding roller 115 may also include a pair of auxiliary rollers 116 displaced between the pickup roller 117 and the feeding roller 115 to convey the recording medium P.

The delivery roller 113 is installed at an outlet side of the printhead 111, and delivers the completely printed recording medium outwardly from the image forming apparatus. The recording medium P, which could be paper or the like, is delivered from the image forming apparatus, and is then stacked on the stacking unit 140. The delivery roller 113 includes a star wheel 113A installed along the width direction of the recording medium P, and a support roller 113B disposed opposite to the star wheel 113A to support a rear side of the recording medium P. When the recording medium P passes under the nozzle unit 112, the ink droplets are ejected on an upper surface of the recording medium. At this point, the recording medium P may become made wet by the ink droplets, so that the recording medium P may be waved. Serious waving may cause the recording medium P to come in contact with a bottom surface of the nozzle unit 112 or body 110, so that the ink droplets which are not yet dried spread on the recording medium and pollute the image. In addition, there is a possibility that a spacing between the recording medium P and the nozzle unit 112 is not constantly maintained due to the waving of the recording medium P. The star wheel 113A prevents the recording medium P, conveyed downwardly, from coming into contact with the bottom of the nozzle unit 112 or the body 110. The star wheel 113A also prevents the spacing between the recording medium P and the nozzle unit 112 from varying. To this end, at least a portion of the star wheel 113A protrudes from the nozzle unit 112 so that the portion of the star wheel 113A point-contacts the upper surface of the recording medium P.

With the above construction, since the star wheel 113A point-contacts the upper surface of the recording medium P, preventing the ink image, ejected on the upper surface of the recording medium, which is not yet dried, from being polluted. In addition, several star wheels may be installed to smoothly convey the recording medium P. When several star wheels are installed in parallel with the conveying direction of the recording medium P, a plurality of support rollers corresponding to the respective star wheels should also be provided.

In addition, when the printing is continuously implemented, after the recording medium P is delivered and stacked on the stacking unit 140, a next recording medium P may be delivered before the ink droplets printed on the upper surface of the previous recording medium P have dried, which may pollute a rear surface of the next recording medium P. In order to prevent the pollution of the next recording medium, a separate drying unit (not shown) may be further provided.

The support member 114 is disposed under the printhead 111 to maintain the spacing between the nozzle unit 112 and the recording medium P in a desired interval, and supports the rear surface of the printing medium P to be conveyed. The spacing between the nozzle unit 112 and the recording medium P is approximately 0.5 mm to 2.5 mm.

The printhead unit 105 prints the image by ejecting ink droplets on the recording medium P, and includes a body 110, a printhead 111 disposed under the body 110, a nozzle unit 112 provided on the printhead 111, and a carriage 106 that is mounted with the body 110. The body 110 having the printhead 111 is mounted on the carriage 106. A feeding roller 115 is rotatably installed at an inlet side of the nozzle unit 112, whereas a delivering roller 113 is rotatably installed to an outlet side of the nozzle unit 112.

Referring to FIG. 4A, the printhead 111 includes a nozzle unit 112. The printhead 111 employs a thermal heater or a piezoelectric device to eject ink. The printhead 111 is made to have a high resolution through a semiconductor manufacturing process such as etching, deposition, or sputtering. In addition, the nozzle unit 112 is provided with a number of nozzle arrays to eject ink droplets on the recording medium P to print the image. The nozzle unit 112 corresponds to the width of the recording medium P or is longer than the width of the recording medium P. The nozzle unit 112 is installed to be substantially parallel with the y-direction of FIG. 3 so as to be substantially perpendicular to the conveying direction of the recording medium P.

According to one aspect of the present invention, the nozzle unit 112 includes a first nozzle array 112A and a second nozzle array 112B, the first and second nozzle arrays 112A and 112B having a number of nozzles of different sizes and being arranged in parallel to each other. The ejecting operations of the first and second nozzle arrays 112A and the 112B are controlled by the controller 130. Each of the first and second nozzle arrays 112A and 112B are provided with large nozzles 112L and small nozzles 112S. The nozzles 112L and 112S may be alternatively arranged. In addition, the respective nozzles of the first and second nozzle arrays 112A and 112B are arranged in parallel with the conveying direction of the recording medium P. Specifically, each large nozzle 112L of the first nozzle array 112A and each small nozzle 112S of the second nozzle array 112B, and each small nozzle 112S of the first nozzle array 112A and each large nozzle 112L of the second nozzle array 112B are arranged in a one-to-one relationship in parallel with the x-direction of FIG. 3. Thus, if a nozzle in the first nozzle array 112A fails to operate, the defective nozzle in the first nozzle array may be effectively compensated for by the corresponding nozzle of the second nozzle array 112B. Meanwhile, if a nozzle in the second nozzle array 112B fails, the defective nozzle in the second nozzle array may be effectively compensated for by the corresponding nozzle of the first nozzle array 112A.

According to embodiments of this invention, the respective nozzles of the first and second nozzle arrays 112A and 112B are displaced in parallel with the first direction, and may be staggered. Also, FIG. 4A illustrates that the respective nozzles are arranged in one consecutive array, while FIG. 4B illustrates that a plurality of nozzle groups may be staggered. In FIG. 4B, reference numeral 112C indicates a nozzle unit to eject cyan ink droplets, reference numeral 112M indicates a nozzle unit to eject magenta ink droplets, reference numeral 112Y indicates a nozzle unit to eject yellow ink droplets, and reference numeral 112K indicates a nozzle unit to eject black ink droplets. As described above, the first and second nozzle arrays 112A and 112B may have various shapes.

Although not shown, the body 110 is provided with a storage space to store ink. The body 110 includes a chamber communicating with the respective nozzles, which are capable of ejecting the ink droplets (for example, a piezoelectric device, a thermally driven heater, or the like), a channel to supply the ink stored in the body 110 (for example, an orifice), a manifold to supply the ink flowing in through the channel to the chamber (i.e., a common channel), and a restrictor to supply the ink from the manifold to the respective chambers (i.e., a separate channel), which are well known to those skilled in the art and, thus, are not described in detail herein.

Referring to FIG. 5, the body 110 is mounted on the carriage 106. The printhead 111 is mounted on the carriage 106 connected to the body 110 in a cartridge manner. A carriage transferring unit 160 reciprocates the carriage 106 in the second direction.

The carriage transferring unit 160 includes a driving unit 162 to reciprocate the carriage 106, and a guide unit 108 to guide the carriage 106. The driving unit 162 receives power from the ink-jet image forming apparatus, and is connected to the carriage 106 to reciprocate the carriage 106. According to an aspect of the present invention, a piezoelectric actuator, which drives a precision device, such as an optical mirror, is utilized as the driving unit 162. The piezoelectric actuator is a device driven by voltage and has a positional precision of several μm and a high frequency response characteristic. Hence, accurately ejecting the ink droplets in a desired position of the recording medium P. Although in the present embodiment the carriage 106 is reciprocated by the piezoelectric actuator, the scope of the present invention is not limited to this arrangement.

The guide unit 108 guides the carriage 106, reciprocated by the driving unit 162. In the embodiment of FIG. 5, the guide unit 108 includes a connection 107 and a guide shaft 108A. The connection 107 penetrates one side of the carriage 106. The guide shaft 108A is inserted into a hollow portion of the connection 107 to guide the carriage 106. In an alternative embodiment, shown in FIG. 6, the guide unit 108 includes a guide rail 108B. The guide rail 108B is installed to one side or both sides of the carriage 106 to guide the carriage 106.

Referring to FIG. 3, the defective nozzle or a weak nozzle, which does not eject ink droplets normally, of the nozzle unit 112 provided on the printhead 111 is detected by a detecting unit 132. When the printhead 111 uses a thermal heater to eject ink droplets, the defective nozzle is a consequence of a short-circuit of the heater, or a malfunction of a drive circuit of the heater or an electric component, such as an FET, which may be easily detected. Similarly, when the printhead 111 uses a piezoelectric actuator, the defective nozzle is a consequence of a defect of the piezoelectric actuator or a problem of the circuit that drives the piezoelectric actuator, which may be easily detected. However, in some cases the defective nozzle is not easily detected.

A printing of a test page is performed to detect the defective nozzle. Since the portion to be printed by the defective nozzle has a lower printing density due to missing dots, the portion may be detected by use of the detecting unit 132, which may comprise an optical sensor. The detecting unit 132 includes a light emitting sensor (for example, a light emitting diode) to emit light onto the recording medium P, and a light receiving sensor to receive the light reflected from the recording medium P. An output signal from the light receiving sensor is input to the detecting unit 132, and is then transferred to the controller 130. The light emitting sensor and the light receiving sensor may be integrally or separately configured. The construction and operation of the detecting unit 132 are widely known to those skilled in the art, and, thus, are not described in detail herein.

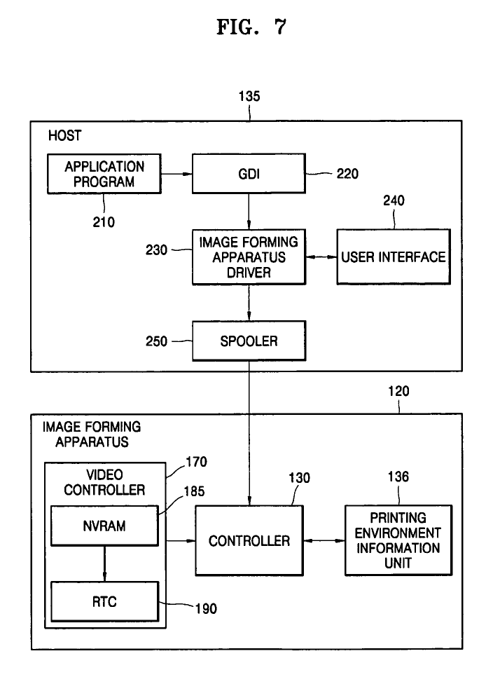

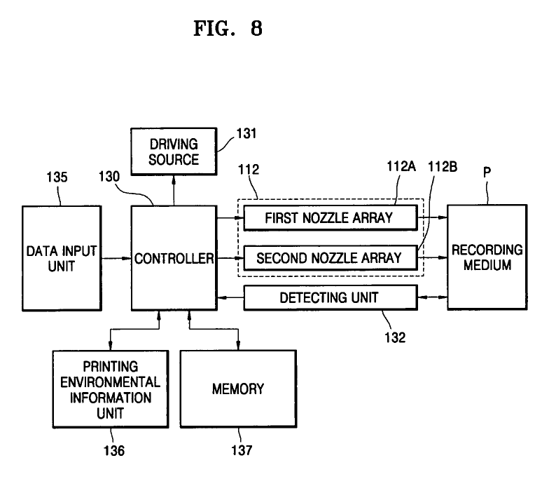

FIG. 7 is a block diagram illustrating the whole construction of an image forming system according to an embodiment of the present invention, and FIG. 8 is a block diagram illustrating a process of compensating for a defective nozzle according to an embodiment of the present invention. The image forming system in FIG. 7 includes a data input unit 135 and an ink-jet image forming apparatus 120.

Referring to FIG. 7, the data input unit 135 receives image data to be printed from an external device, such as a personal computer, a digital camera, or a personal digital assistant, in the order of papers to be printed. In this embodiment, the data input unit 135 is a personal computer. The data input unit 135 has an application program 210 installed therein, a graphics device interface (GDI) 220, an image forming apparatus driver 230, a user interface 240, and a spooler 250.

An application program 210, such as MS-Word, allows for a making and an editing of an image to be outputted by the image forming apparatus 120. The graphics device interface 220 is a module of an operating system of the data input unit 135, and receives the object produced by the application program 210, transmits the object to the image forming apparatus driver 230, and generates a command for the object requested by the image forming apparatus driver 230.

The image forming apparatus driver 230 is an application program installed in the data input unit 135, and generates a command that is interpreted by the image forming apparatus 120. The user interface 240 of the image forming apparatus driver 230 is also an application program installed in the data input unit 135, and produces environmental parameters associated with the command to be generated by the image forming apparatus driver 230. The spooler 250 is an application program of the operation system of the data input unit 135, and transmits the command generated by the image forming apparatus driver 230 to an input/output device (not shown) connected to the image forming apparatus 120.

The image forming apparatus 120 includes a video controller 170, a controller 130, and a printing environmental information unit 136. The video controller 170 has a non-volatile random access memory (NVRAM) 185 and a real-time clock (RTC) 190.

The video controller 170 interprets the command generated by the image forming apparatus driver 230 to create a bitmap, which is transmitted to the controller 130. The controller 130 then transmits the bitmap created by the video controller 170 to the respective elements of the image forming apparatus 120 to form the image on the recording medium P. Then, printing is performed by the image forming apparatus 120 through the process described above. A process of compensating for the defective nozzle according to aspects of the present invention will now be described.

Referring to FIGS. 3 and 8, the controller 130 is mounted on a mother board of the image forming apparatus 120 to control an ejecting operation of the nozzle unit 112 provided on the printhead 111, a conveying operation of the recording medium transferring units 117, 115 and 113, and a conveying operation of the carriage transferring unit 160. In particular, the controller 130 initiates the operation of the respective elements so that the ink droplets ejected by the nozzle unit 112 may be printed in the wanted portion of the recording medium P. Also, the controller 130 stores the image data which is input through the data input 135 in the memory 137, and determines whether the image data of the page to be printed is stored in the memory 137.

The printing environmental information unit 136 stores a plurality of pieces of printing environmental information on printing environments in which the image data input to the data input unit 135 is printed. Specifically, the printing environmental information unit 136 stores printing environmental information on the printing environment input from the user interface 240. Herein, the printing environment includes a printing density, a resolution, a size of a recording medium, a kind of a recording medium, temperature, humidity, consecutive printing information, and the like.

If the image data has been completely stored, the controller 130 operates the driving source 131 so that the recording medium P is conveyed by the recording medium transferring units 117, 115 and 113, being driven by the driving source 131, through the apparatus. The controller 130 operates the carriage transferring unit 160 according to the printing environmental information stored in the printing environmental information unit 136 and the information on the defective nozzle detected by the detecting unit 132. The carriage transferring unit 160 reciprocates the carriage 106 according to the printing environmental information. To obtain a higher printing density or resolution, a reciprocating range of the carriage 106 operated by the carriage transferring unit 160 is large according to the printing environmental information.

If a defective nozzle is not detected, the controller 130 operates the nozzle unit 112 to eject the ink droplets when the recording medium P enters the nozzle unit 112. The controller 130 creates and outputs control signals to control the operation of the first and second nozzle arrays 112A and 112B to print the image data on the recording medium P. The first and second nozzle arrays 112A and 112B receive the control signals to print the image data on the recording medium P.

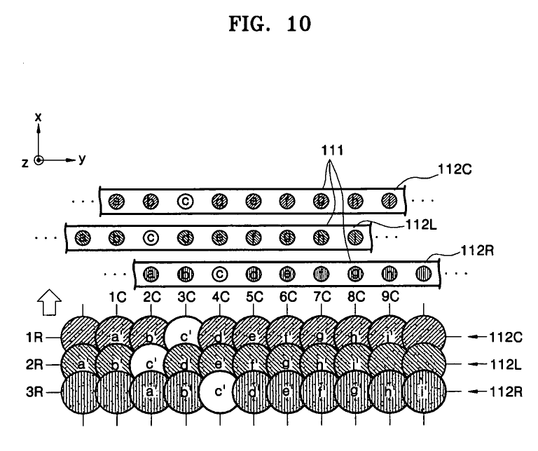

If the defective nozzle is detected, the controller 130 controls the operation of the carriage transferring unit 160, as shown in FIG. 10, to reciprocate the printhead 111 in the y-direction of FIG. 3 and, thus, the image data is printed on the printing medium P. The effect of the defective nozzle is dispersed by the reciprocation of the printhead 111. The reciprocating range of the printhead 111 is determined by the printing environment input from the user interface 240.

According to aspects of the present invention, the controller 130 compensates for the defective nozzle of the first nozzle array 112A by using the second nozzle array 112B, and may compensate for the defective nozzle of the second nozzle array 112B by using the first nozzle array 112A.

A method of compensating for a defective nozzle according to an embodiment of the present invention will now be described with reference to the drawings.

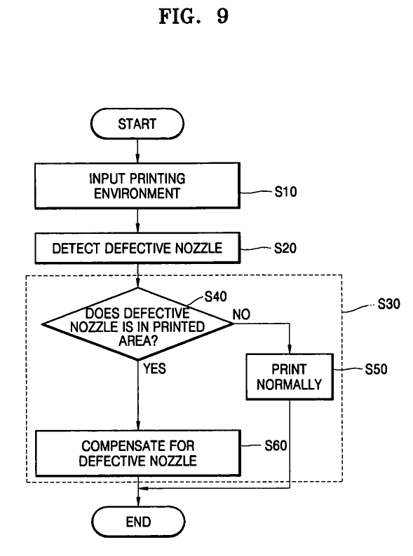

FIG. 9 is a flowchart illustrating a method of compensating for a defective nozzle according to an embodiment of the present invention, and FIG. 10 is a view illustrating an operation of compensating for a defective nozzle of an ink-jet image forming apparatus when printing the image in a solid pattern according to an embodiment of the present invention. Herein, the solid pattern means a high density image. In FIGS. 9 and 10, reference numerals a, b, c, d, e, f, g, h, and i indicate a nozzle array of the nozzle unit 112, respectively, while reference numerals a′, b′, c′, d′, e′, f′, g′, h′, and i′ indicate an array of dots ejected by the nozzles, respectively. In addition, 1R, 2R, and 3R indicate a row of dots printed by moving a nozzle unit P, respectively, while 1C, 2C, 3C, 4C, 5C, 6C, 7C, 8C, and 9C indicate a column of dots printed by the respective nozzle arrays, respectively. The case where nozzle c is defective is described as an example in the present embodiment.

Referring to FIG. 9, the method of compensating for the defective nozzle includes: receiving the printing environmental information (op 10), detecting the defective nozzle of the nozzle unit 112 (op 20), and compensating for the defective nozzle (op 30). The operation of receiving the printing environmental information and the operation of detecting the defective nozzle (op 10 and op S20) have been described above.

The operation of compensating for the defective nozzle (op 30) comprises determining whether a region to be printed corresponds to the defective nozzle (op 40). If the region to be printed does not correspond to the defective nozzle, printing is normally performed (op 50). Meanwhile, if the region to be printed corresponds to the defective nozzle, the region is not normally printed, and a missing or white line appears in the printed image. Since the white or missing line is easily noticed, the white or missing line significantly affects the printing quality. Hence, the white or missing line should be compensated for.

According to an aspect of the present invention, if the region to be printed corresponds to the position of the defective nozzle, the printhead 111 is reciprocated according to the printing environmental information stored in the printing environmental information unit 136, as shown in FIG. 10, to perform the printing. Specifically, the reciprocating range of the printhead 111 is determined depending upon the printing environment input by the user interface 240. For example, in the case where the printing density is low, the effect of the defective nozzle is slight. Hence, the printhead 111 is slightly moved or is not moved at all. When the printing density is high, the effect of the defective nozzle is more visible. Therefore, the reciprocating range of the printhead 111 should be increased. Specifically, the controller 130 determines the reciprocating range of the printhead 111 according to the printing environment input from the user interface 240. The printhead 111, operated by this process, is shown in FIG. 10. Referring to FIG. 10, the printhead 111 ejects the ink droplets while reciprocating in the order of 112C, 112L, 112R, 112C, and 112L. When the printhead 111 is positioned in the location 112C, a missing dot c′ is created in the printed image of the recording medium P by the nozzle c. The recording medium P moves in the direction illustrated by the arrow, and simultaneously the printhead 111 is moved in the position 112L by the carriage transferring unit 160, so that the missing dot c′ is created in the printed image of the recording medium P by the nozzle c. The recording medium P moves continuously in the direction illustrated by the arrow, and the printhead 111 is moved to the position 112R by the carriage transferring unit 160, so that the missing dot c′ is created in the printed image of the recording medium P. By repeating the above process, the missing dot c′ created by the defective nozzle c appears in the 3^{rd} row, 3C, of the 1^{st} column, 1R, the 2^{nd} row, 2C, of the 2^{nd} column, 3R, and the 4th row, 4C, of the 3^{rd} column, 4C. That is, the missing dot c′ is dispersed in the printed image of the recording medium P in a staggered pattern.

As is described above, since the printhead 111 reciprocates to eject the ink droplets, it is important that the ink droplets are ejected in the accurate position on the recording medium P. In order to print the ink droplets on the accurate position on the recording medium P, the controller 130 synchronizes the operation of transferring the recording medium by the recording medium transferring units 117, 115 and 113, the operation of ejecting the ink droplets by the printhead 111, and the operation of reciprocating the printhead 111. Specifically, the controller 130 complements the position information of the dot ejected by the printhead 111 according to the input printing environment, and controls the operation of the respective elements to perform the printing.

In an alternative embodiment, the defective nozzle may be compensated for with first and second nozzle arrays 112A and 112B of which two large and small nozzles are staggered, as shown in FIG. 4A. Specifically, if the defective nozzle belongs to the first nozzle array 112A, the defective nozzle may be compensated for with the second nozzle array 112B. Meanwhile, if the defective nozzle belongs to the second nozzle array 112B, the defective nozzle may be compensated for with the first nozzle array 112A. For example, if the large nozzle 112L of first nozzle array 112A is defective, the defective large nozzle may be compensated for with the small nozzle 112S of the second nozzle array 112B. Also, if the small nozzle 112S of second nozzle array 112B is defective, the defective small nozzle may be compensated for with the large nozzle 112L of the first nozzle array 112A.

As is described above, the apparatus and method according to present invention properly compensates for missing dots created by defective nozzles, according to the printing environment input through the user interface 240. In addition, after the carriage 106 is mounted on the guide shaft 108A or after the carriage 106 is mounted on the guide rails 108B arranged in parallel, the carriage 106 is reciprocated by the carriage transferring unit 160 for printing. Hence, missing dots created by defective nozzles are dispersed in a printed image on the recording medium P, so that white or missing lines are unseen.

An image forming apparatus and method of compensating for a defective nozzle according to the present invention compensates for printing defects, such as a white line which may be easily noticed by a user by dispersing missing dots over the recording medium P. In addition, according to the present invention, a range in which the printhead reciprocates is varied according to printing environments. As a result, printing defects resulting from defective nozzles may be effectively dispersed according to the printing environment so as to optimize printing quality. In addition, according to the present invention, defects caused by defective nozzles are compensated for using the same color ink while reciprocating the printhead so as to overcome the limitations in U.S. Pat. No. 5,581,284 and to minimize the effect of the defective nozzles on printing quality. In addition, according to aspects of the present invention, dots of ink ejected from large and small nozzles are dispersed over a printing medium, the roughness of a printed image reduces. Also, according to aspects of the present invention, when a large nozzle in a nozzle array is a defective nozzle, a printing failure caused by the large defective nozzle is compensated for using a small nozzle in another nozzle array so as to reduce ink consumption. In addition, according to aspects of the present invention, an effect of compensating for printing failure may be improved by arranging two nozzle arrays to be parallel and adjusting the arrangements of nozzles in each of the nozzle arrays.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. An ink-jet image forming apparatus, comprising:
a recording medium transferring unit to transfer a recording medium in a first direction;
a printhead to extend substantially parallel with a second direction, the second direction crossing the first direction, on which a nozzle unit is defined, the nozzle unit having nozzles through which ink droplets are ejected onto the recording medium;
a carriage with the printhead mounted thereon;
a carriage transferring unit to reciprocate the carriage in the second direction; and
a controller to synchronize operations of the recording medium transferring unit, the printhead, and the carriage transferring unit, and to print the ink droplets ejected by the nozzles in a desired position of the recording medium so as to disperse an effect of a defective nozzle.

2. The ink-jet image forming apparatus according to claim 1, further comprising a detecting unit to detect the defective nozzle in the nozzle unit.

3. The ink-jet image forming apparatus according to claim 2, further comprising:
a data input unit to receive image data to be printed; and
a printing environmental information unit to store a plurality of printing environmental information corresponding to a printing environment when the image data inputted to the data input unit is printed under a desired printing environment,
wherein the controller regulates a reciprocating range of the carriage according to the printing environmental information stored in the printing environmental information unit and information on the defective nozzle detected by the detecting unit.

4. The ink-jet image forming apparatus according to claim 3, wherein the printing environment comprises at least one of a printing density, a resolution, a size of the recording medium, a kind of the recording medium, a temperature, humidity, and consecutive printing information.

5. The ink-jet image forming apparatus according to claim 3, wherein two large and small nozzles are alternatively arranged in the nozzle unit.

6. The ink-jet image forming apparatus according to claim 1, wherein the carriage transferring unit includes:
a driving unit to reciprocate the carriage; and
a guide unit to guide the carriage.

7. The ink-jet image forming apparatus according to claim 6, wherein the driving unit includes a piezoelectric actuator coupled to the carriage, to reciprocate the carriage.

8. The ink-jet image forming apparatus according to claim 6, wherein a connection penetrates the carriage, and the guide unit includes a guide shaft inserted into the connection to guide the carriage.

9. The ink-jet image forming apparatus according to claim 6, wherein the guide unit includes a guide rail to guide the carriage.

10. The ink-jet image forming apparatus according to claim 6, wherein two large and small nozzles are alternatively arranged in the nozzle unit.

11. A method of compensating for a defective nozzle in an ink-jet image forming apparatus including a printhead having a nozzle unit of a length at least corresponding to a width of the recording medium, the method comprising:
receiving printing environment information;
detecting the defective nozzle in the nozzle unit; and
reciprocating the printhead in a longitudinal direction according to whether the defective nozzle is detected and based on the printing environment information to disperse an effect of the defective nozzle.

12. The method according to claim 11, wherein the printing environment information comprises at least one of a printing density, a resolution, a size of the recording medium, a kind of the recording medium, a temperature, humidity, and consecutive printing information.

13. The method according to claim 11, wherein the reciprocating comprises determining whether the defective nozzle corresponds to an area to be printed.

14. The method according to claim 13, further comprising, if the defective nozzle does not correspond to the area to be printed, normally performing the printing.

15. The method according to claim 11, further comprising synchronizing an operation of transferring the recording medium, an operation of ejecting an ink droplet, and an operation of reciprocating the printhead to print the ink droplets in a desired position of the recording medium.

16. The method according to claim 15, wherein two large and small nozzles are alternatively arranged in the nozzle unit.

17. The method according to claim 13, further comprising, if the defective nozzle corresponds to the area to be printed, regulating the reciprocating range of the carriage according to the printing environmental information stored in the printing environmental information portion.

18. The method according to claim 17, further comprising synchronizing transferring the recording medium by a recording medium transferring unit, ejecting an ink droplet by the printhead, and reciprocating the printhead to print the ink droplets in a desired position of the recording medium.

19. The method according to claim 18, wherein two large and small nozzles are alternatively arranged in the nozzle unit.

20. An image forming apparatus, through which a recording medium is transferred in a first direction, and in which a printhead, on which nozzles are defined to eject ink droplets toward and along a width of the recording medium, reciprocates in a second direction, the apparatus comprising:
a detecting unit to detect a defective nozzle from among the nozzles; and
a controller to receive printing environmental information and, if the defective nozzle is detected, to control the transferring of the recording medium and the reciprocation of the printhead based on the printing environmental information so as to position at least one non-defective nozzle to make up for the defective nozzle and/or to position the defective nozzle so as to disperse an effect of the defective nozzle

21. The apparatus according to claim 20, further comprising a recording medium transferring unit to transfer the recording medium through the apparatus.

22. The apparatus according to claim 20, further comprising a carriage unit to support the reciprocation of the printhead.

23. The apparatus according to claim 21, wherein the recording medium transferring unit comprises:
a pickup roller to pickup sheets of the recording medium from a stack;
a feeding roller to feed the recording medium through the apparatus; and
a delivering roller to eject the recording medium from the apparatus.

24. The apparatus according to claim 20, further comprising a star wheel to maintain a predetermined distance between the recording medium and the printhead.

25. The apparatus according to claim 20, further comprising a support member disposed under the printhead to maintain a spacing between the nozzles and the recording medium as being approximately 0.5 mm to 2.5 mm.

26. The apparatus according to claim 20, wherein the printhead comprises a thermal heater and/or a piezoelectric device to eject ink.

27. The apparatus according to claim 20, wherein the nozzles are arranged in a nozzle unit extending along the length of the printhead, the nozzle unit being organized into nozzle arrays.

28. The apparatus according to claim 27, wherein the nozzle unit comprises a first nozzle array, and a second nozzle array, the first and second nozzle arrays each having a number of first and second different sized nozzles defined therein and which are arranged in parallel to each other.

29. The apparatus according to claim 28, wherein each first nozzle of the first nozzle array and each second nozzle of the second nozzle array, and each second nozzle of the first nozzle array and each first nozzle of the second nozzle array are arranged in a one-to-one relationship in parallel with the first direction.

30. The apparatus according to claim 29, wherein, if the defective nozzle is a nozzle in the first nozzle array, the corresponding nozzle of the second nozzle array compensates for the defective nozzle, and, if a nozzle in the second nozzle array is the defective nozzle, the corresponding nozzle of the first nozzle array compensates for the defective nozzle.

31. The apparatus according to claim 30, wherein the respective nozzles of the first and second nozzle arrays are displaced in parallel with the first direction.

32. The apparatus according to claim 31, wherein the respective nozzles of the first and second arrays are staggered.

33. The apparatus according to claim 27, wherein the nozzle arrays extend along the length of the printhead.

34. The apparatus according to claim 27, wherein the nozzle arrays each eject ink of various colors or each nozzle array ejects ink of various colors.

35. The apparatus according to claim 22, wherein the printhead is mounted on the carriage, and wherein a carriage transferring unit reciprocates the carriage in the second direction.

36. The apparatus according to claim 35, wherein the carriage transferring unit comprises:
a piezoelectric actuator to drive the reciprocation of the carriage; and
a guide unit to guide the reciprocation of the carriage.

37. The apparatus according to claim 20, wherein the detecting unit comprises:
a light emitting sensor to emit light onto the recording medium; and
a light receiving sensor to receive the light reflected from the recording medium.

38. The apparatus according to claim 20, further comprising a printing environmental information unit to store the printing environmental information on printing environments of the apparatus for particular printing operations.

39. The apparatus according to claim 38, wherein the printing environment information comprises at least one of a printing density, a resolution, a size of a recording medium, a kind of a recording medium, temperature readings, humidity readings, and consecutive printing information.

40. A method of compensating for a defective nozzle of a printhead of an image forming apparatus, comprising:
receiving printing environmental information;
detecting the defective nozzle; and
compensating for the defective nozzle, wherein the compensating comprises:
determining whether a region to be printed corresponds to the defective nozzle;
if the region to be printed does not correspond to the defective nozzle, normally performing a printing operation;
if the region to be printed corresponds to the defective nozzle, reciprocating the printhead according to the printing environmental information to disperse an effect of the defective nozzle and concurrently performing the printing operation.

41. The method according to claim 40, further comprising determining a reciprocating range of the printhead based upon the printing environment information.
